(19) United States
(12) Patent Application Publication
(10) Pub. No.: US 2025/0095514 A1
(43) Pub. Date: Mar. 20, 2025

(54) JOINT DISLOCATION REDUCTION SIMULATION APPARATUS

(71) Applicants: Shanna Simone Strauss, Incline Village, NV (US); Joseph David Colley, Incline Village, NV (US)

(72) Inventors: Shanna Simone Strauss, Incline Village, NV (US); Joseph David Colley, Incline Village, NV (US)

(73) Assignee: Clunk Innovations LLC, Incline Village, NV (US)

(21) Appl. No.: 18/829,094

(22) Filed: Sep. 9, 2024

Related U.S. Application Data
(60) Provisional application No. 63/581,637, filed on Sep. 9, 2023.

(51) Int. Cl. G09B 23/32

(52) U.S. Cl. CPC G09B 23/32

(57) ABSTRACT

The present technology is generally related to medical training and assessment devices and tools, and in particular, to devices that simulate joint dislocation reductions to be used in medical training scenarios. A joint dislocation simulator is described, The simulator comprises at least two articular elements and at least one connector element. The at least two articular elements simulate different bones that make up a joint. The at least one connector element is configured to connect the at least two articular elements. The connector(s) simulate ligaments, tendons, muscles, cartilage, binding tissues, and/or other elements that connect articular surfaces. Additional or alternative aspects may be described and/or claimed.

### CROSS-REFERENCE TO RELATED APPLICATIONS

The present application claims priority to U.S. Provisional App. No. 63/581,637 filed on Sep. 9, 2023, the contents of which is hereby incorporated by reference in its entirety.

### TECHNICAL FIELD

The present disclosure is generally related to medical training and assessment devices, injury simulators, and in particular, to devices that simulate joint dislocations and reductions for training medical professionals.

### BACKGROUND

A joint dislocation occurs when an abnormal separation in a joint, where two or more bones meet. Treatment for joint dislocation can be accomplished by a closed reduction, which involves the skilled manipulation of joint fragments to return the bones to their normal position, orientation, and/or alignment. Training healthcare professionals on how to reduce joint dislocations can be difficult, especially when using simulation devices or dummies.

Currently, there are few simulation devices to train medical personnel on how to reduce joint dislocations. In particular, there are no existing devices that can simulate multiple joints and (sub) luxations in a single device. And while there is a dearth of devices that can simulate dislocation reductions in simulation centers, there are currently no mobile (e.g., transportable) devices to simulate dislocations that can be used to practice reductions for multiple joints.

### SUMMARY

Aspects of the present technology include a joint dislocation simulator. In various embodiments, the joint dislocation simulator comprises at least two articular elements and at least one connector element. The at least two articular elements simulate different bones that make up a joint. The at least one connector element is configured to connect the at least two articular elements. The connector(s) simulate ligaments, tendons, muscles, cartilage, binding tissues, and/or other elements that connect articular surfaces.

A first example includes a joint dislocation simulation apparatus, comprising: a first articular element; a second articular element; and a connector element configured to couple the first articular element to the second articular element.

A second example includes the first example and/or any other example discussed herein, wherein the first articular element and the second articular element simulate different bones that make up a joint.

A third example includes the any of the preceding examples and/or any other example discussed herein, wherein the connector element simulates at least one of one or more ligaments, one or more tendons, one or more muscles, one or more cartilage, or one or more binding tissues.

A fourth example includes any of the preceding examples and/or any other example discussed herein, wherein the joint dislocation simulation apparatus is configured to simulate multiple types of joints, wherein the multiple types of joints include plane joints, ball and socket joints, hinge joints, pivot joints, condyloid joints, and saddle joints.

A fifth example includes any of the preceding examples and/or any other example discussed herein, wherein the first articular element includes at least one hole through a body of the first articular element.

A sixth example includes any of the preceding examples and/or any other example discussed herein, wherein the second articular element includes at least one hole through a body of the second articular element.

A seventh example includes any of the preceding examples wherein the connector element is configured to be inserted or threaded into the at least one hole of the first articular element and the at least one hole of the second articular element.

An eighth example includes any of the preceding examples and/or any other example discussed herein, wherein the at least one hole of the first articular element or at least one hole of the second articular element includes a corresponding track configured to receive the connector element and align the first articular element and the second articular element.

A ninth example includes any of the preceding examples and/or any other example discussed herein, wherein the second articular element comprises at least one socket.

A tenth example includes any of the preceding examples and/or any other example discussed herein, wherein the first articular element comprises at least one articulation surface configured to fit into the at least one socket of the second articular element when the joint dislocation simulation apparatus simulates a reduced joint.

An eleventh example includes any of the preceding examples and/or any other example discussed herein, wherein the at least one socket is a concave surface.

A twelfth example includes any of the preceding examples and/or any other example discussed herein, wherein the concave surface is formed between at least two articulation surfaces of the second articular element.

A thirteenth example includes any of the preceding examples, wherein the at least one articulation surface extends laterally away from a body of the first articular element.

A fourteenth example includes any of the preceding examples, wherein the at least one articulation surface extends longitudinally away from a body of the first articular element.

A fifteenth example includes any of the preceding examples and/or any other example discussed herein, wherein the at least one articulation surface of the first articular element is a first articulation surface, the first articular element comprises a second articulation surface configured to rest on an articulation surface of the second articular element when the joint dislocation simulation apparatus simulates a reduced joint.

A sixteenth example includes any of the preceding examples and/or any other example discussed herein, wherein the first articular element comprises at least one socket.

A seventeenth example includes any of the preceding examples and/or any other example discussed herein, wherein the second articular element comprises at least one articulation surface configured to fit into the at least one socket of the first articular element.

An eighteenth example includes any of the preceding examples and/or any other example discussed herein, wherein the first articular element and the second articular element are configured to be pulled away from one another, and the connector element is configured to resist a distorting influence caused by the first and second articular elements being pulled apart.

A nineteenth example includes any of the preceding examples and/or any other example discussed herein, wherein the connector element is formed from at least one elastic material.

A twentieth example includes joint dislocation simulation apparatus, comprising at least two articular elements connected by at least one connector element, wherein at least one articular element of the at least two articular elements includes a socket and at least one articular element of the at least two articular elements includes an articulation surface configured to be inserted into the socket, and wherein the articulation surface is to rest outside of the socket to simulate a dislocated joint and the articulation surface is to rest inside the socket to simulate a reduced joint.

A twenty-first example includes the twentieth includes the twentieth example in combination with any other example discussed herein.

### BRIEF DESCRIPTION OF THE DRAWINGS

In the drawings, which are not necessarily drawn to scale, like numerals may describe similar components in different views. Like numerals having different letter suffixes may represent different instances of similar components. Embodiments are illustrated by way of example, and not limitation, in the figures of the accompanying drawings in which:

FIG. 1 depicts a side view of an example joint dislocation simulator according to a first embodiment. FIG. 2 depicts an exploded view of the example joint dislocation simulator of the joint dislocation simulator according to the first embodiment. FIG. 3 depicts a bottom view of the joint dislocation simulator according to the first embodiment. FIG. 4 depicts a close-up view of a first articular element of the joint dislocation simulator according to the first embodiment. FIG. 5 depicts a top view of the joint dislocation simulator according to the first embodiment. FIG. 6 depicts a side view of a second articular element of the joint dislocation simulator according to the first embodiment. FIG. 7 depicts a side view of the first articular element of the joint dislocation simulator according to the first embodiment. FIG. 8 depicts top views of the first and second articular elements of the joint dislocation simulator according to the first embodiment. FIG. 9 depicts close-up side and front views of the second articular element of the joint dislocation simulator according to the first embodiment. FIG. 10a depicts a close-up side view of the first articular element of the joint dislocation simulator according to the first embodiment. FIG. 10b depicts a top view of the first articular element of the joint dislocation simulator according to the first embodiment. FIG. 10c depicts a front view of the first articular element of the joint dislocation simulator according to the first embodiment.

FIGS. 11 and 12 show side views of an example joint dislocation simulator according to a second embodiment. FIG. 13 depicts a top view of the example joint dislocation simulator according to the second embodiment. FIG. 14 depicts a front view of the example joint dislocation simulator according to the second embodiment. FIGS. 15 and 16 depict isometric views of the example joint dislocation simulator according to the second embodiment. FIG. 17 depicts a side view of a first articular element of the example joint dislocation simulator according to the second embodiment. FIG. 18 depicts a front view of the first articular element of the example joint dislocation simulator according to the second embodiment. FIG. 19 depicts a top view of the first articular element of the example joint dislocation simulator according to the second embodiment. FIG. 20 depicts an isometric view of the first articular element of the example joint dislocation simulator according to the second embodiment. FIGS. 21 and 22 depict side views of a second articular element of the example joint dislocation simulator according to the second embodiment. FIG. 23 depicts a front view of the second articular element of the example joint dislocation simulator according to the second embodiment. FIG. 24 depicts an isometric view of a second articular element of the example joint dislocation simulator according to the second embodiment.

FIGS. 25 and 26 depict side views of an example joint dislocation simulator according to a third embodiment. FIG. 27 depicts a side hidden detail view of the example joint dislocation simulator according to the third embodiment. FIG. 28 depicts an isometric view of the example joint dislocation simulator according to the third embodiment. FIG. 29 depicts an isometric hidden detail view of the example joint dislocation simulator according to the third embodiment. FIG. 30 depicts an isometric exploded hidden detail view of the example joint dislocation simulator according to the third embodiment. FIG. 31 depicts a front view of the example joint dislocation simulator according to the third embodiment. FIG. 32 depicts a front hidden detail view of the example joint dislocation simulator according to the third embodiment. FIG. 33 depicts a back view of the example joint dislocation simulator according to the third embodiment. FIG. 34 depicts a back hidden detail view of the example joint dislocation simulator according to the third embodiment. FIG. 35 depicts a top view of the example joint dislocation simulator according to the third embodiment. FIG. 36 depicts a top hidden detail view of the example joint dislocation simulator according to the third embodiment. FIG. 37 depicts a side hidden detail view of a first articular element of the example joint dislocation simulator according to the third embodiment. FIG. 38 depicts a front hidden detail view of the first articular element of the example joint dislocation simulator according to the third embodiment.

FIGS. 39, 40, 41, and 42 depict example operations of the joint dislocation simulator of the first embodiment to simulate dislocations and reductions. FIGS. 43a, 43b, 43c, and 43d depict show various manipulations of the joint dislocation simulator of the first embodiment.

### DETAILED DESCRIPTION

The present technology is generally related to medical training and assessment devices and tools, and in particular, to devices that simulate joint dislocation reductions to be used in medical training scenarios.

A joint dislocation (also referred to as “luxation”) occurs when an abnormal separation in a joint, where two or more bones meet. A partial dislocation is referred to as a subluxation. For purposes of the present disclosure, the term “(sub)luxation” may refer to a luxation, a subluxation, or both. Dislocations are often caused by sudden trauma on a joint, which may be based on an impact or fall. A joint dislocation can cause damage to the surrounding ligaments, tendons, muscles, and nerves.

Treatment for joint dislocation can be accomplished by a closed reduction, which involves the skilled manipulation of joint fragments to return the bones to their normal position, orientation, and/or alignment. Reduction should only be performed by trained medical professionals because reductions can cause injury to soft tissue and/or the nerves and vascular structures around the dislocation, especially when performed incorrectly. Reductions require a familiarity with anatomical structures and a nuanced motion against strong muscle tension. Multiple effective reduction techniques have been described, however, there is no general consensus regarding preferred approaches to reducing specific joint luxations.

Currently, there are few simulation devices to train medical personnel on how to reduce joint dislocations. In particular, there are no existing devices that can simulate multiple joints and (sub)luxations in a single device. And while there is a dearth of devices that can simulate dislocation reductions in simulation centers, there are currently no mobile (e.g., transportable) devices to simulate dislocations that can be used to practice reductions for multiple joints.

One existing device is the Shoulder Injury Simulation (IS) model task trainer (the “MN simulator”) developed and sold by MN Medical™ and Sawbones®, a Pacific Research

Laboratories, Inc., company. See Lance Baily, Should Joint Dislocation Simulator, HEALTHYSIMULATION.COM a DBA of WaterWell LLC (23 Dec. 2019). The MN simulator is only capable of simulating shoulder joint dislocation. Additionally, the MN Medical simulator must be placed on a firm surface in order to function properly.

Another existing simulation device for shoulder reductions is the ReducTrain

device described in Taneja et al., Simulation device for shoulder reductions: overview of prototyping, testing, and design instructions, ADVANCES IN SIMULATION, vol. 8, no. 8 (9 Mar. 2023) (“[Taneja]”). Similar to the MN simulator, the ReducTrain is limited to simulating shoulder joint dislocation and is unable to simulate other joints.

Both the MN simulator and the ReducTrain suffer from the same deficiencies. For example, both the MN simulator and the ReducTrain only simulate a single joint meaning that only a limited number techniques can be applied by a medical practitioner during training. Additionally, the MN simulator and the ReducTrain are limited in the types of locations and environments in which they can be used, which means that these simulators cannot be used in typical settings where medical practitioners are likely to encounter joint dislocations (i.e., they cannot be used in the field). Furthermore, the MN simulator and the ReducTrain cannot be used underneath clothing to simulate a joint dislocation in a realistic medical scenarios.

Another existing simulation device is the inexpensive reduction trainer and demonstration (IRTD) model described in Hopkins et al., Train Yourself: Pop Goes the Shoulder, Emergency Physicians Monthly (5 Apr. 2021). The IRTD model provides an anatomic visualization of the joint, and is somewhat mobile. However, the IRTD model is still limited to the shoulder joint and is incapable of simulating other joints. Furthermore, most reductions are closed reductions where a medical practitioner does not handle human bones, and therefore, the IRTD model does cannot adequately simulate the “feel” of performing a joint reduction.

The present disclosure describes a joint dislocation simulation device that is capable of simulating multiple joints and joint dislocations and reductions, allowing medical practitioners to practice multiple reduction techniques in a variety of medical training scenarios. The joint simulator described herein can simulate multiple joint reductions in the field and under clothing, providing real-time tactile feedback of a joint dislocation reduction in simulated real-life medical scenarios. Providing simulations of joint reductions have been shown to improve medical professionals' skills and knowledge utilization in real-life. The simulator described herein can be used for multiple joints in a variety of scenarios and a variety of locations, which enhances the educational value of practicing joint reductions in comparison to using existing models/devices.

The arrangement of elements making up the present joint dislocation simulator better mimic the feel of handling human body parts when performing reduction techniques, including a “clunk” that practitioners often feel when reducing a joint from dislocation to location. This “clunk” feeling is an indication that the joint has properly been located. By using the device(s) described herein, medical professionals can better learn how to safely reduce dislocations and improve their reduction skills in near-real-life situations, allowing these medical professionals to provide improved healthcare outcomes with real patients.

Furthermore, the present joint dislocation simulator has a significantly reduced form factor in comparison to existing joint dislocation simulators (or medical dummies) on the market. This reduced (smaller) form factor allows the simulator to be easily transported to various locations, making it easier to train more medical professionals to properly perform joint reduction techniques in the settings or environments in which they would normally practice such techniques. For example, the smaller form factor of the present joint simulator allows the device to be easily transported into wilderness settings for training search-and-rescue personnel, forest rangers, ski patrollers, medics, soldiers and other military personnel, and the like. The smaller form factor also allows the present joint dislocation simulator to be placed underneath clothing as mentioned previously. Moreover, because the present joint dislocation simulator has a smaller form factor than most other simulation devices and/or medical dummies, the present joint dislocation simulator can be manufactured using less complex manufacturing processes, and using less resources, than existing simulation devices and/or medical dummies. Furthermore, it should be noted that although various example embodiments are described in terms of simulating human joints, the joint dislocation simulator of the present technology can also be used to simulate joint dislocations and reductions of other animals.

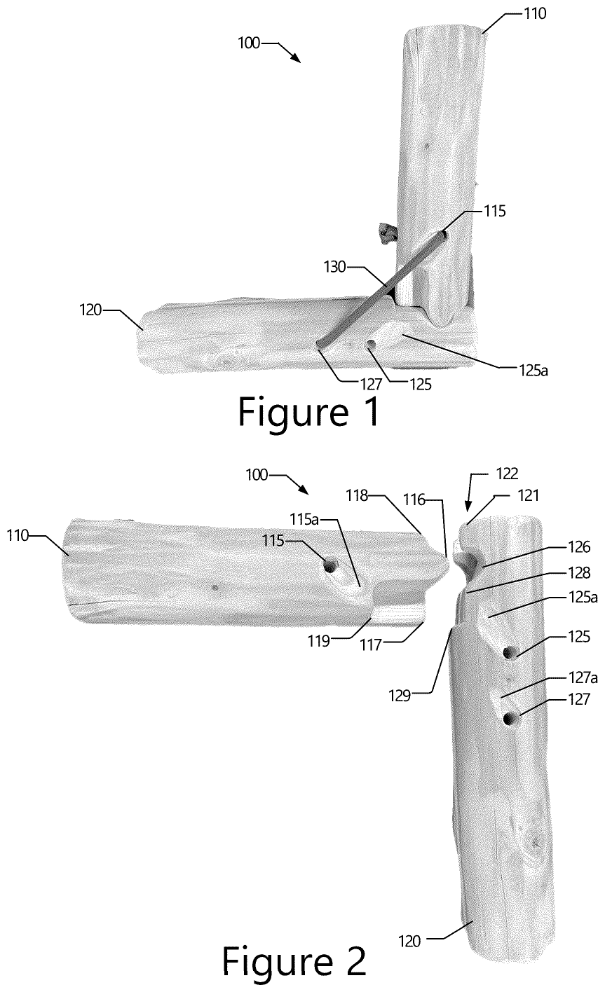

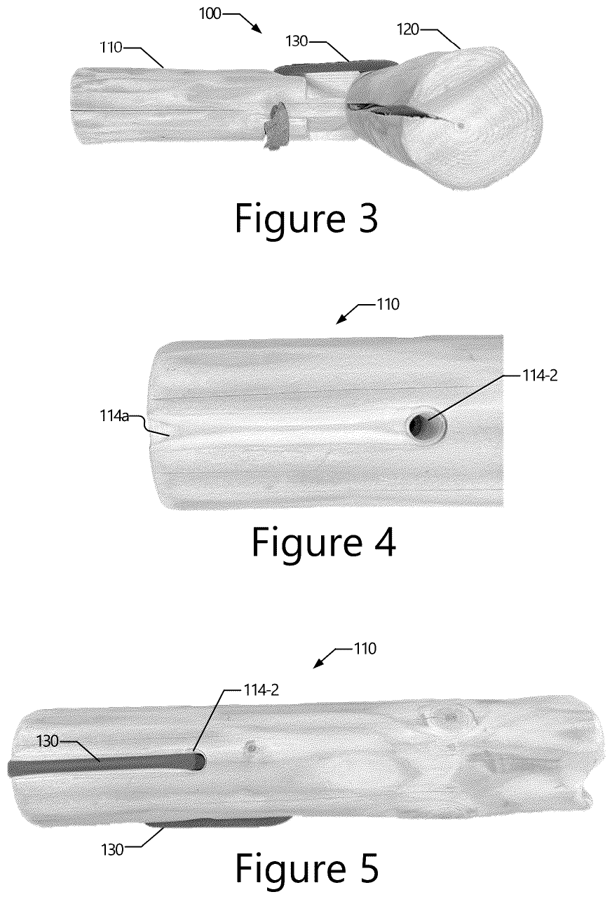

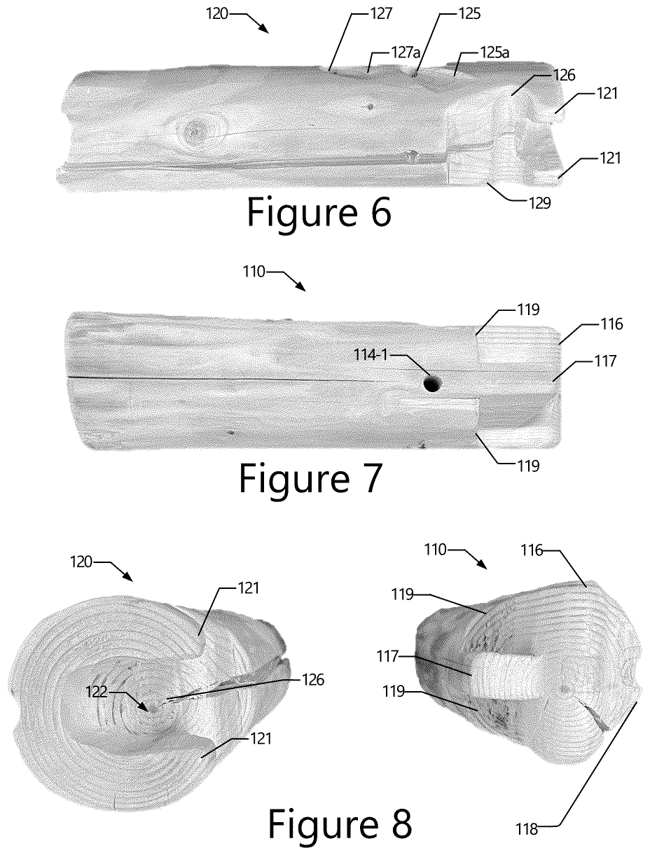

FIGS. 1-10 show various views of an example joint dislocation simulator 100, and components thereof, according to a first embodiment of the present technology. The simulator 100 includes a first articular element 110, a second articular element 120, and connector element 130 (also referred to herein as “connector 130” or the like). The two articular elements 110, 120 simulate different bones that make up a joint. The connector 130 connects the two articular elements 110, 120 to one another. The connector 130 simulates ligaments, tendons, muscles, cartilage, binding tissues, and/or other elements that connect articular surfaces. Although this example embodiment shows a single connector 130, it should be understood that multiple connectors 130 may be used to simulate different strength ligaments, tendons, muscles, etc.

As shown by FIGS. 2-10, the articular elements 110, 120 include one or more holes 114-1, 114-2, 115, 125, 127 (also referred to as “vias”, “channels”, and/or the like) through which the connector 130 can be inserted. The connector 130 allows for adjustments to the tension in real-time allowing a user to provide various levels of tension to the simulator 100. The connector 130 can be pulled through looped through one or more holes 114-1, 114-2, 115, 125, 127 in different combinations, and various different fastening means can be used to adjust the tension of the connector 130. The connector 130 can be looped or inserted through different ones of the holes 114-1, 114-2, 115, 125, 127 to simulate different joints, which may have different tension strengths. Although not shown, multiple connectors 130 can be included and connected to the articular elements 110, 120 in various combinations. The different holes 114-1, 114-2, 115, 125, 127 and different strength connector(s) 130 can be used to adjust the tension the connector(s) 130 at different strengths, calibrations, and tensions to simulate different joints. In this example, the connector 130 is shown as a bungee cord, however, any other type(s) of connectors or fastening means can be used.

As shown by FIGS. 2, 4, 9 the holes 114-2, 115, 125, and 127 of articular elements 110, 120 may include corresponding channels 114a, 115a, 125a, and 127a (also referred to as “canals”, “depressions”, “guides”, “carve-outs”, “tracks”, and/or the like) on/in which connector 130 may be received or otherwise rest. The channels 114a, 115a, 125a, and 127a may be used to attempt to keep the connector 130 in an alignment on or with the articular element 110. The connector 130 runs through, or otherwise is guided by, one or more tracks (e.g., tracks/channels 114a, 115a, 125a, 127a, and/or the like) to keep the articular elements 110, 120 aligned in a same or similar manner that various tendons, ligaments, muscles, etc. may align various bone(s) in the body. As an example, FIG. 4 shows a close-up view of one end of the articular element 110. This end of the articular element 110 includes a channel 114a in which connector 130 may be received or otherwise rest, and a hole 114-2 through which the connector 130 may be inserted. FIG. 5 shows an example of the articular element 110 with the connector 130 resting in/on the channel 114a and inserted into the hole/via 114-2.

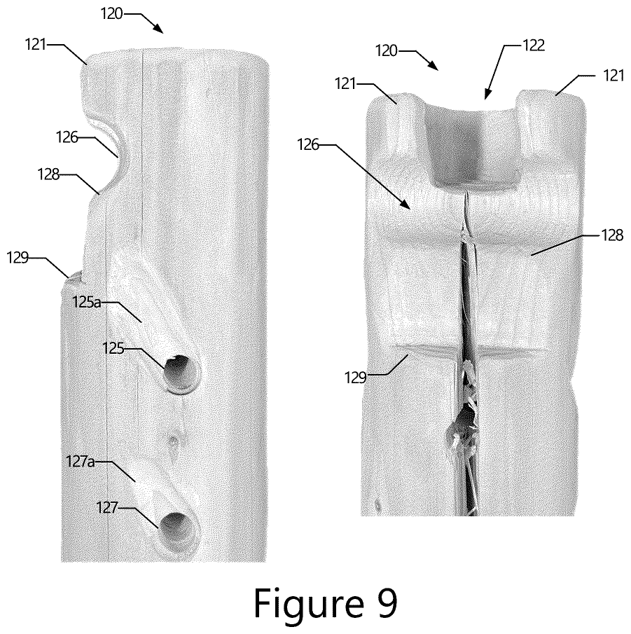

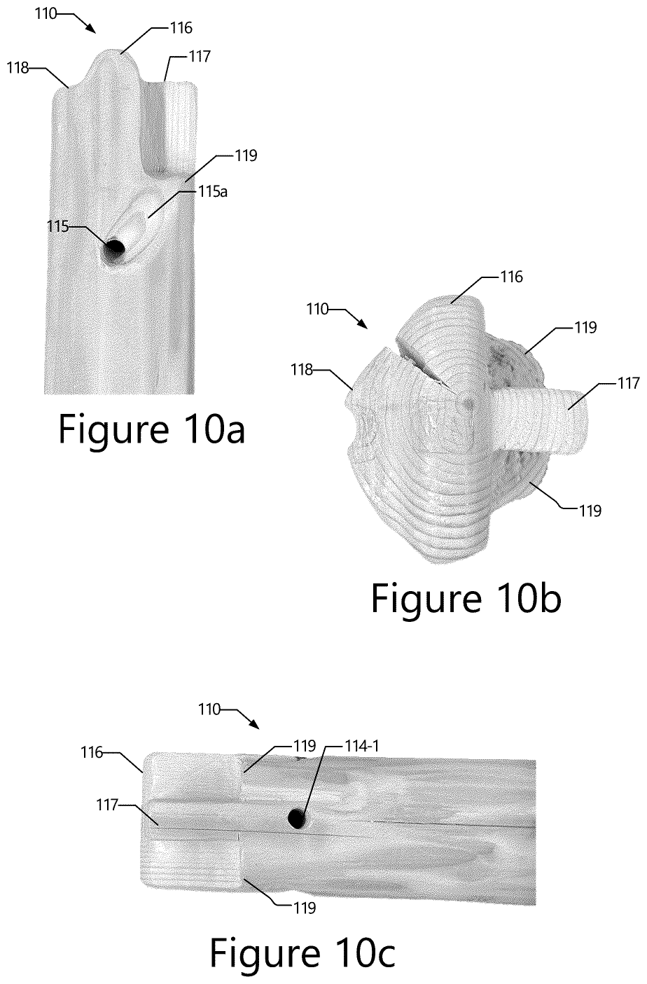

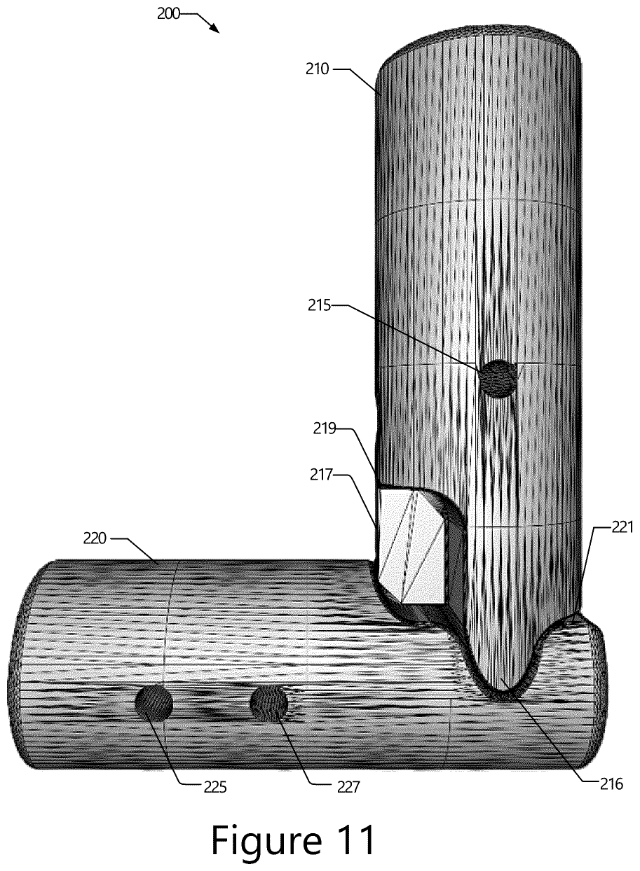

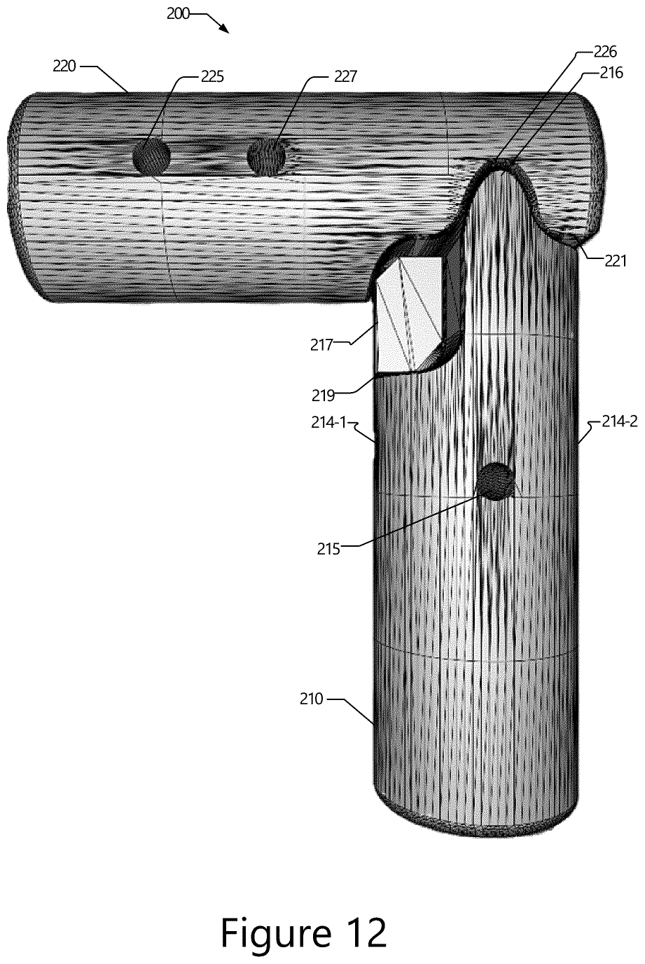

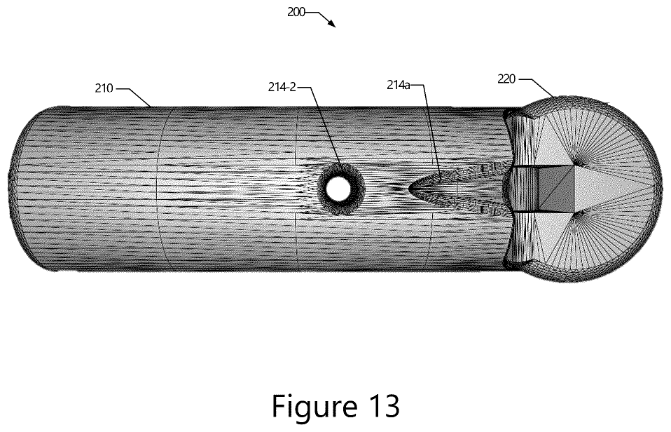

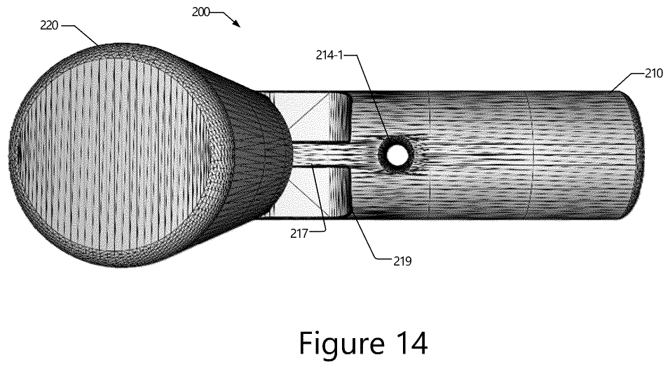

FIGS. 11-24 show various views of an example joint dislocation simulator 200, and components thereof, according to a second embodiment of the present technology. The simulator 200 includes a first articular element 210 and a second articular element 220. And although not shown by FIGS. 11-24, one or more connector elements may also be included to connect the two articular elements 210, 220 to one another. In the examples of FIGS. 11-24, elements 210, 214-1, 214-2, 214a, 215, 216, 217, 218, 219, 220, 221, 222, 225, 226, 227, 228, 229 may be the same or similar to elements 110, 114-1, 114-2, 114a, 115, 116, 117, 118, 119, 120, 121, 122, 125, 126, 127, 128, 129 of the first embodiment shown by FIGS. 1-10. The example joint dislocation simulator 200 may also be operated in a same or similar manner as the example joint dislocation simulator 100.

FIGS. a1-38 show various views of an example joint dislocation simulator 300, and components thereof, according to a third embodiment of the present technology. The simulator 300 includes a first articular element 310, a second articular element 320, and connector elements 330a and 330b that connect the first and second articular elements 310, 320.

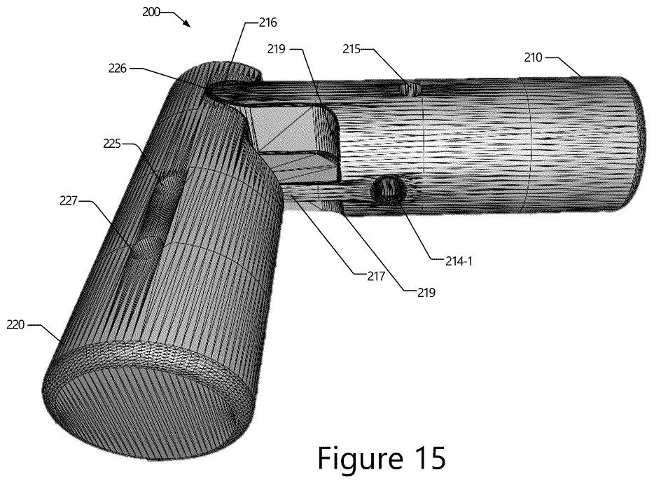

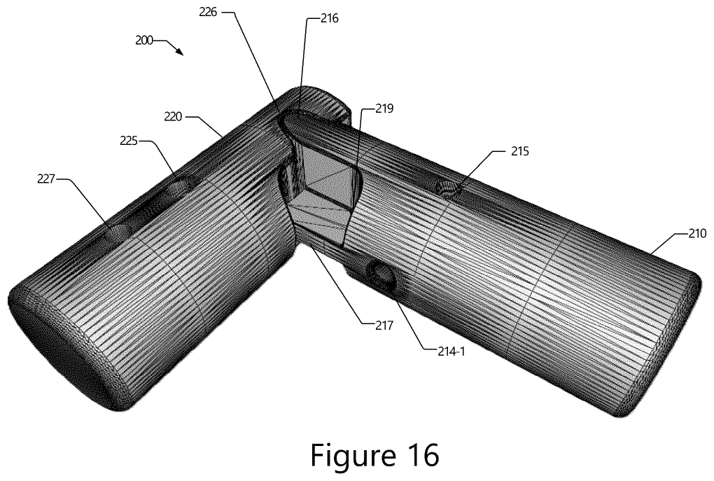

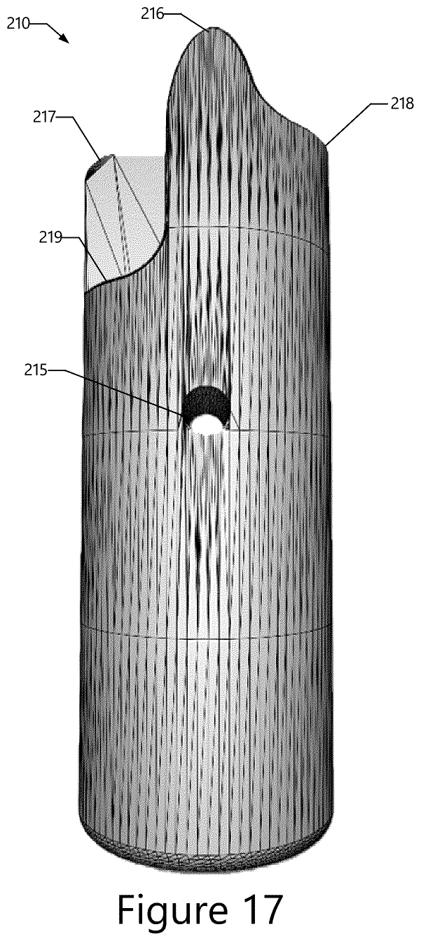

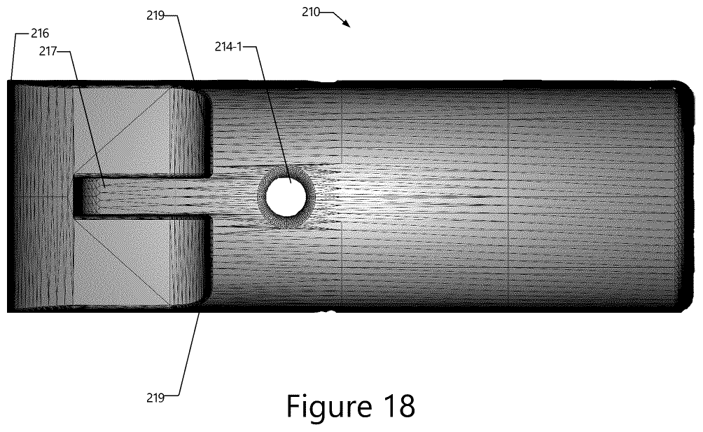

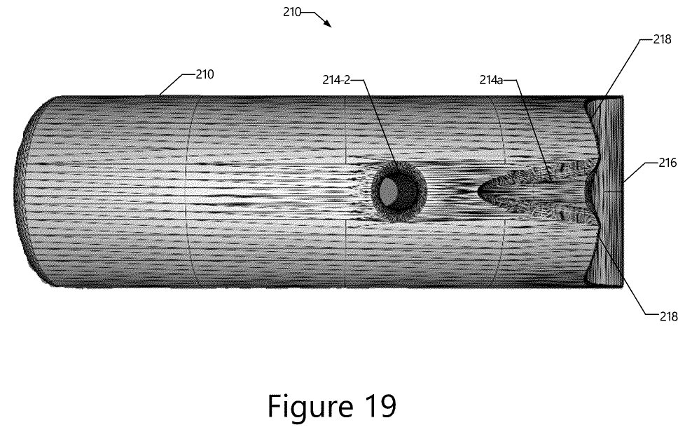

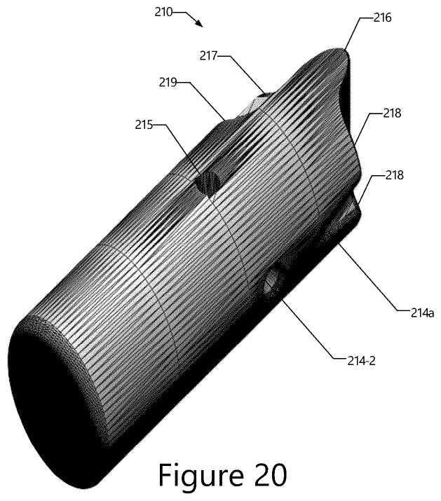

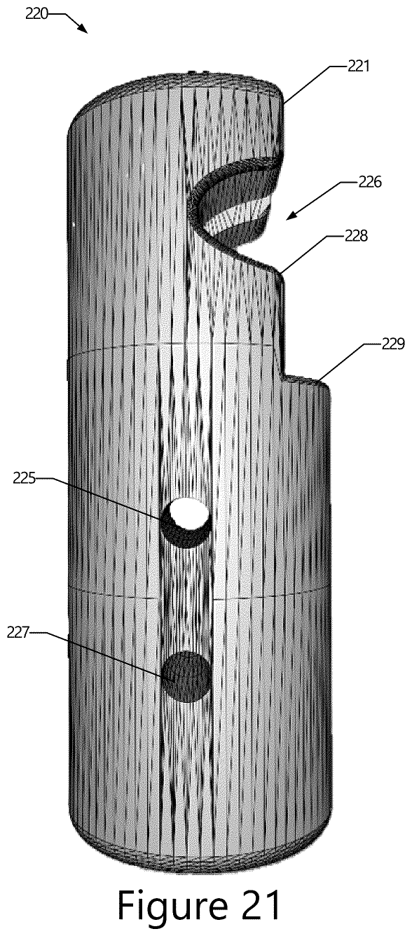

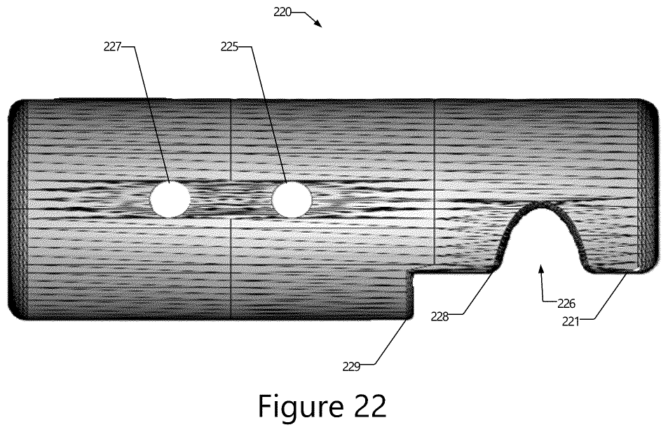

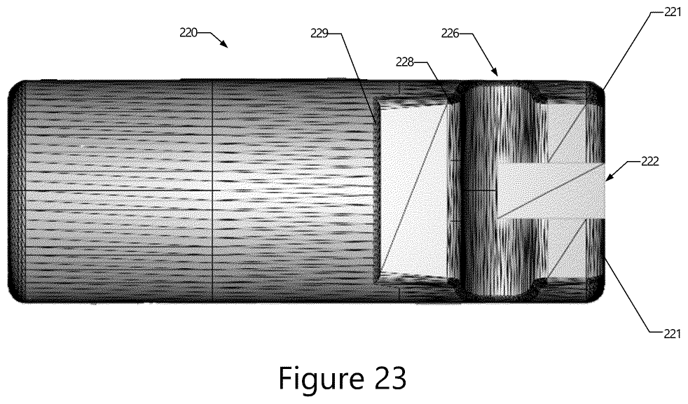

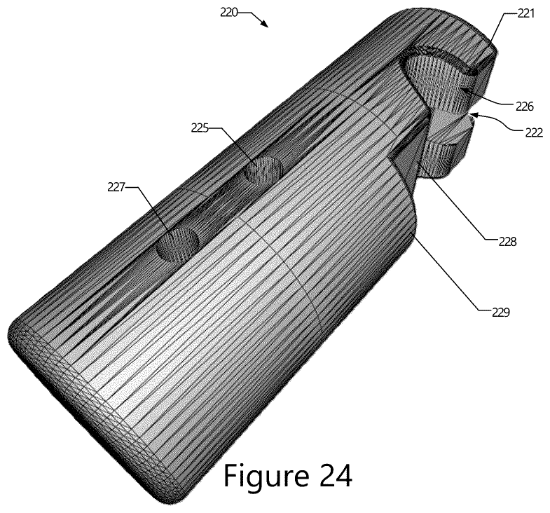

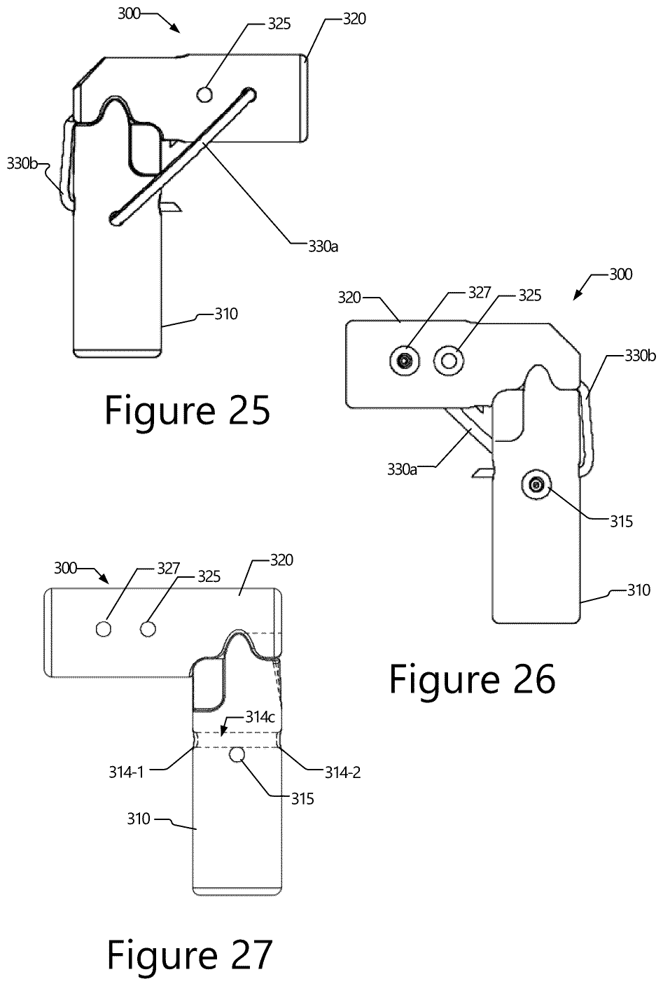

In the examples of FIGS. 25-38, elements 310, 314-1, 314-2, 314a, 315-1, 315-2, 316, 317, 318, 319, 320, 321, 322, 325-1, 325-2, 326, 327-1, 327-2, 328, 329, 330a, 330b may be the same or similar to elements 110, 114-1, 114-2, 114a, 115, 116, 117, 118, 119, 120, 121, 122, 125, 126, 127, 128, 129, 130 of the first embodiment shown by FIGS. 1-10 and/or elements 210, 214-1, 214-2, 214a, 215, 216, 217, 218, 219, 220, 221, 222, 225, 226, 227, 228, 229, 230 of the second embodiment shown by FIGS. 11-24. The example joint dislocation simulator 300 may also be operated in a same or similar manner as the example joint dislocation simulator 100 and/or 200.

The examples of FIGS. 25-38 also shows channel 314c (also referred to herein as a “cavity” or the like) between holes 314-1 and 314-2, channel 315c between holes 315-1 and 315-2, channel 325c between holes 325-1 and 325-2, and channel 327c between holes 327-1 and 327-2. Connector 330a and/or 330b may be threaded in or inserted into channels 314c, 315c, 325c, 327c in various ways depending on the type of joint one wishes to simulate. In addition, the third embodiment also includes a channel 333 in which the connector 330b may rest or otherwise be inserted.

In an example, the second articular element 120, 220, 320 simulates an articular socket (an “articular socket element”), which includes one or more notches, depressions, cavities, concavities, receptacles, and/or sockets (collectively referred to herein as “sockets” and/or the like), such as sockets 122, 222 and 126, 226. In this example, the first articular element 110, 210, 310 simulates an articular surface (an “articular surface element”), which includes one or more articulations 116, 216, 316, 117, 217, 317, 118, 218, 318, 119, 229, and/or other elements that fit into the sockets of the articular socket element 120, 220, 320. The articulations may also be referred to as articulation surfaces.

In some implementations, at least one of the articular elements 110, 120, 210, 220, 310, 320 include both sockets and articulations. Additionally or alternatively, both of the articular elements 110, 120, 210, 220, 310, 320 include sockets and articulations. The multiple sockets and multiple articulations may be arranged in multiple ways (e.g., similar to different puzzle pieces) to simulate multiple different joints. In these ways, the articular elements 110, 120, 210, 220, 310, 320 can simulate multiple types of joints, such as plane joint, ball and socket joints, hinge joints, pivot joints, condyloid joints, and saddle joints.

In the examples depicted by FIGS. 1-10 and 39-43d, the articular elements 110, 120 are shown as being formed from wood. However, any additional or alternative type of material (or combination of materials) may be used to form or manufacture articular elements 110, 120, 210, 220, 310, 320 such as, for example, plastic(s) (e.g., polypropylene (PP), polycarbonate (PC), acrylonitrile butadiene styrene (ABS), polyvinyl chloride (PVC), nylon(s), polymethyl methacrylate (PMMA), acrylic, etc.), matte plastic(s) (e.g., matte PP, matte ABS, matte PC, matte PCV, matte nylon(s), etc.), metal, metal alloys, carbon fiber, fiberglass, Kevlar, glass, mate glass, ground glass, composite glass (e.g., glass-ceramic, fiber-reinforced glass, laminated glass, etc.), opal, ceramic material(s), and/or any other suitable material, and/or combinations thereof. In one example, the articular elements 110, 120 can include a core formed of metal, carbon fiber, and/or the like, that is wrapped in one or more materials used to simulate human skin, such as, for example, rubber, silicone, silicone rubber, polyurethane, latex, gelatin, vinyl, thermoplastic elastomers (TPE), one or more foams, and/or any other suitable material, and/or combinations thereof.

The articular elements 110, 120, 210, 220, 310, 320 may be formed to have suitable dimensions (e.g., length, width, depth, volume, weight, mass, thickness, and/or the like) to better simulate human appendages or other body parts. Unlike the conventional simulators, such as those discussed previously, the articular elements 110, 120, 210, 220, 310, 320 are formed to be sufficiently think or voluminous to have the “feel” of human appendages or otherwise have the dimensions that are closer to the physical characteristics of human body parts that are likely to be encountered in real-world reduction scenarios.

Additionally, in the examples depicted by FIGS. 1-10 and 39-43d, the connector element 130 is shown as being formed from, or otherwise embodied as, a bungee cord. However, any additional or alternative type of material (or combination of materials) may be used to form or manufacture connector elements 130, 330a, 330b such as, for example, natural rubber, latex, synthetic rubber, neoprene, ethylene propylene diene terpolymer (EPDM), polypropylene, nylon, polyester, elastic polyurethane, rope made of natural and/or synthetic fibers, spandex (e.g., elastane or Lycra), cotton, canvas, linen, wool, gum, silicon, elastin, magnets (e.g., permanent magnets, ferromagnetic materials, electromagnets, etc.), any desired elastomer, and/or any other suitable material, and/or combinations thereof.

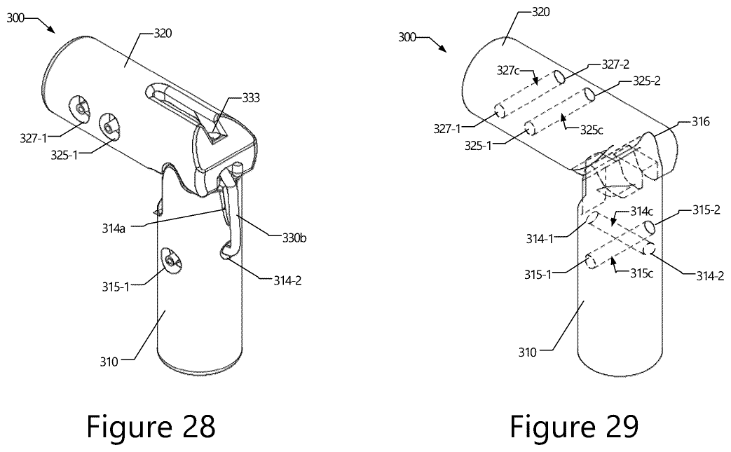

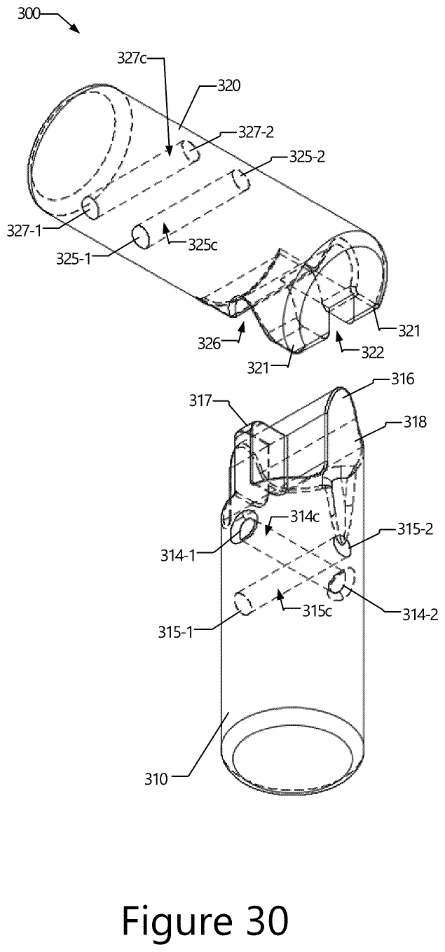

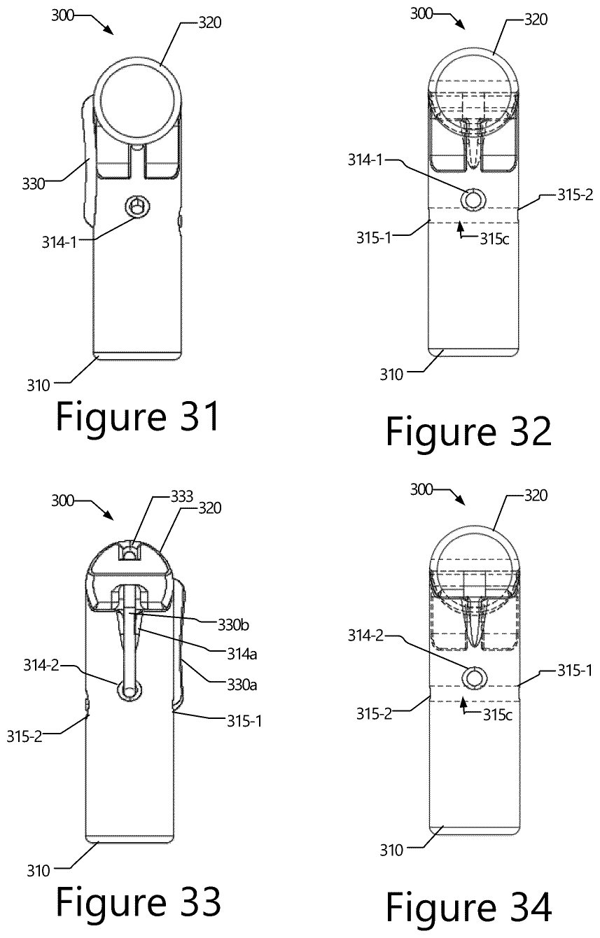

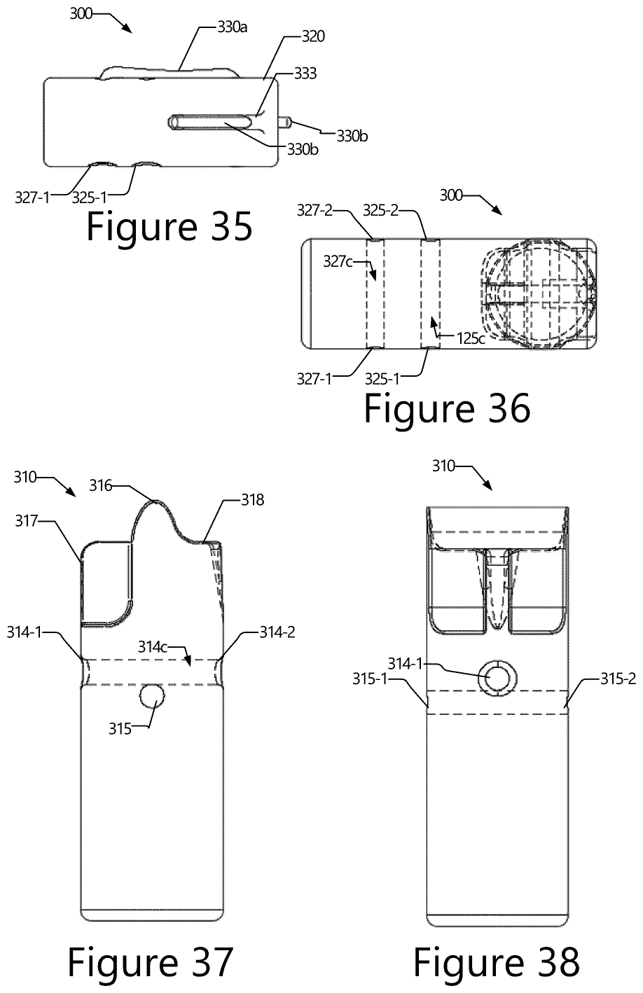

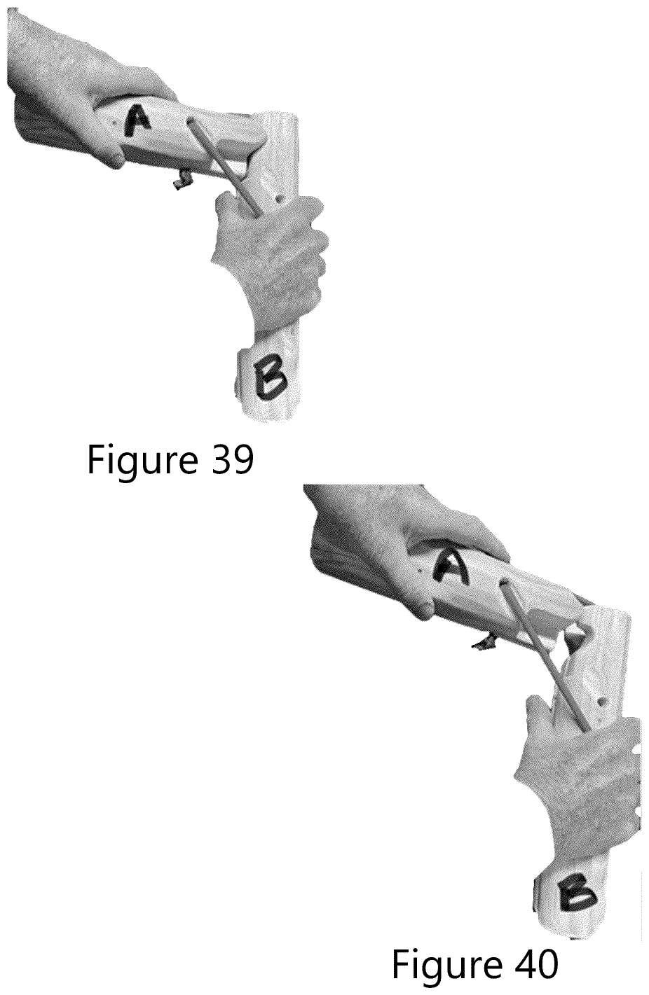

FIGS. 39, 40, 41, and 42 show examples of how the simulator 100 can be manipulated to simulate joint reductions. For simulating the shoulder, elbow, and hip joints, the simulator 100 fits at or about a 90 degree angle with a piece that can move to two positions (dislocated and reduced). When the user performs a reduction technique, the feeling of traction provided by the connector 130 may simulate the “clunk” that is felt from dislocation to location, which indicates that the joint has been realigned properly. Additionally, the rounded socket 126 may also simulate the “clunk” feeling when a reduction is properly performed. As shown by FIG. 39, the simulator 100 is simulating a shoulder joint wherein the shoulder A that is meeting B in the body when reduced and A sits on articular element B when dislocated. This not only simulates the dislocation/reduction but gives the tactile feedback of the loss of the rounded deltoid when the shoulder is dislocated and while reducing the joint you can feel the catching of the arm (humerus) on the cup of the shoulder joint (glenoid). For the elbow it is the reverse of the shoulder.

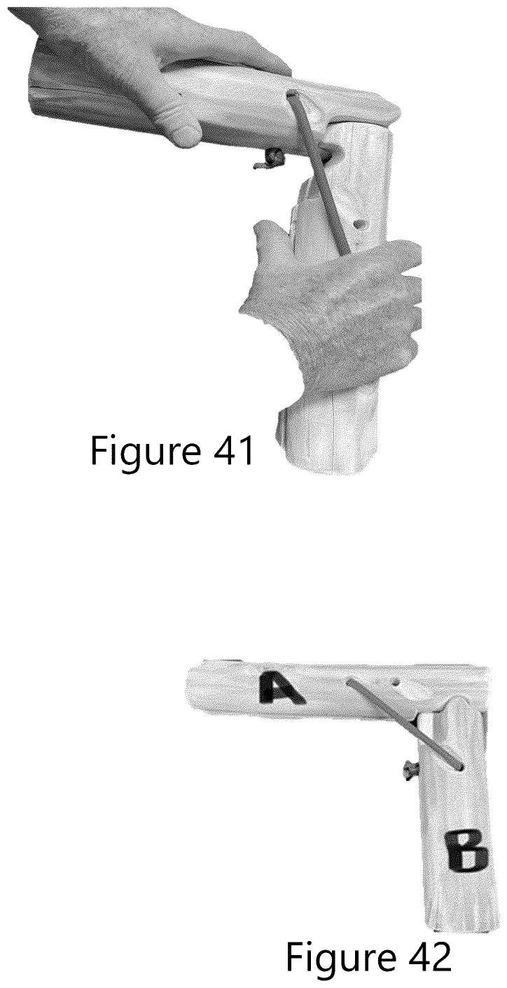

FIGS. 40 and 41 show the shoulder being “located” (e.g., in a normal joint position, orientation, and/or alignment), with articular element A representing the glenoid and articular element B representing the humerus. Laterally (to the side of articular element A where the top of articular element B sits) the simulator 100 simulates the “feel” or “clunk” of a located shoulder. In motion of reducing the dislocation, where a downward and lateral traction releases the humeral head (articular element B) from the glenoid (articular element A).

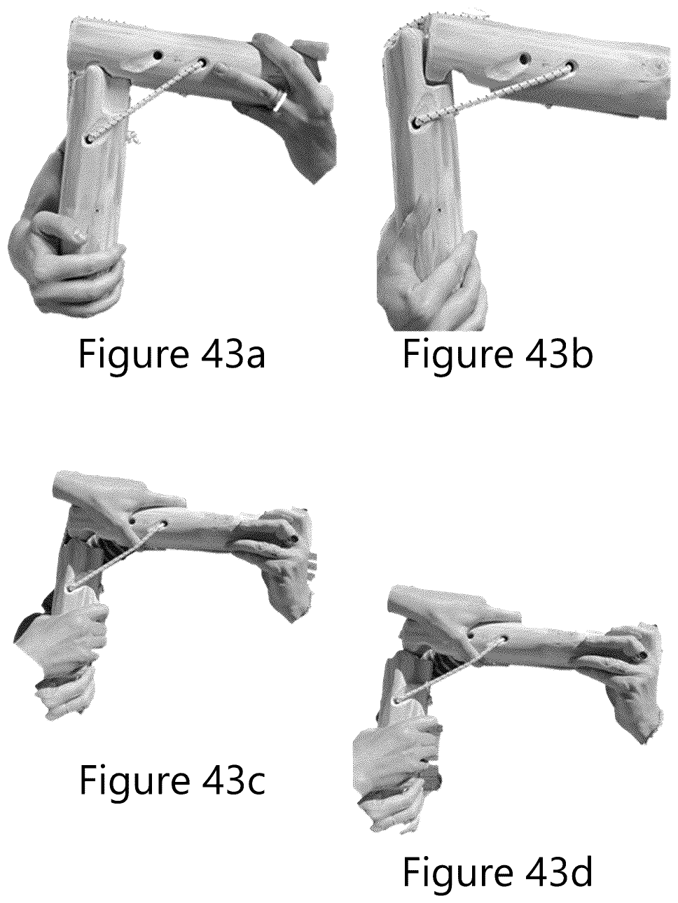

FIG. 42 shows an example of a simulated dislocated shoulder using the simulator 100. The loss of the lateral mass-articular element B is now under articular element A, which simulates a scenario where a shoulder is dislocated and the humerus is caught under the glenoid.

FIGS. 43a-43d show various manipulations of the simulator 100 for simulating should joint reduction techniques. FIG. 43a shows a simulated dislocated shoulder joint. FIG. 43b shows a simulated dislocated shoulder joint. FIG. 43c shows a simulated reduction technique—downward traction on B while A is held in place. FIG. 43d shows a simulated reduction technique—downward traction on B while A is held in place

Other reduction techniques can be practices using the simulator 100. For example, simulating an elbow joint can be performed in the reverse order as the simulated shoulder joint. Here, the posterior dislocated elbow is where the ulna sits behind the humerus, and the elbow relocation simulation can be performed where the ulna and the humerus are realigned. Same forces applied as the humerus but in a different orientation. Reduction technique—anterior traction on articular element B resisted by push force on articular element A.

The hip joint can be simulated in a same or similar manner as the elbow joint. The dislocated hip involves the femur sitting behind the pelvis, and the relocated hip involves the femur sitting in front of the hip. The Reduction technique includes an upward traction on articular element B and downward traction on articular element A.

Additionally or alternatively, the simulator 100 can simulate more additionally multiple joints by duplicating the articular elements (e.g., puzzle piece(s)) on the opposite end of one or more articular elements. For example, additional articular element(s)/joints can be added to the depicted articular elements to allow the user to have the sensation of real life leverage off an additional hinge point.

In summary this is a two to four piece structure with puzzle piece connections held together with bungees to simulate the dislocation and reduction of the shoulder, elbow, and hip. The rod pieces are made out of wood in our prototype but will be reproduced with composite or natural (wood) materials to be durable, light, and tubular to simulate bones while being mobile and easily hidden under clothes. The bungees provide the tension one would experience from muscle/tendons surrounding the joint. The rod pieces fit together such that they provide the tactile feedback of a dislocated joint and the tension exerted on joint during a reduction. This device is portable, durable, and light making it easy to transport it into the field or into different clinical simulation rooms to allow trainees to practice dislocation reduction techniques. The current prototype shows the puzzle piece connection and bungees which are novel designs. This prototype is limited to one joint (which can act as the shoulder, elbow, hip). We will have additional models with longer “limbs” (wood rods) w/secondary hinge points to simulate the hip+knee or shoulder+elbow.

For the purposes of the present document, the following aspects are applicable to the examples and embodiments discussed herein.

As used herein, the singular forms “a,” “an” and “the” are intended to include plural forms as well, unless the context clearly indicates otherwise. The phrase “A and/or B” means (A), (B), or (A and B). For the purposes of the present disclosure, the phrase “A, B, and/or C” means (A), (B), (C), (A and B), (A and C), (B and C), or (A, B and C). The phrase “X(s)” as used herein means at least one X, one or more X, or a set of X. The description may use the phrases “in an embodiment,” “In some embodiments,” “in one implementation,” “In some implementations,” “in some examples”, and the like, each of which may refer to one or more of the same or different embodiments, implementations, and/or examples. The terms “comprises” and/or “comprising,” when used herein, specify the presence of stated features, integers, steps, operations, elements, and/or components, but do not preclude the presence or addition of one or more other features, integers, steps, operation, elements, components, and/or groups thereof. Furthermore, the terms “comprising,” “including,” “having,” and the like, as used with respect to the present disclosure, are synonymous.

The terms “coupled,” “communicatively coupled,” along with derivatives thereof, at least in some examples refer to two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” at least in some examples refers to two or more elements that are in direct contact with one another. The term “communicatively coupled” at least in some examples refers to two or more elements that may be in contact with one another by a means of communication including through a wire or other interconnect connection, through a wireless communication channel or ink, and/or the like.

The term “fabrication” at least in some examples refers to the creation of a metal structure using fabrication means. The term “fabrication means” as used herein refers to any suitable tool or machine that is used during a fabrication process and may involve tools or machines for cutting (e.g., using manual or powered saws, shears, chisels, routers, torches including handheld torches such as oxy-fuel torches or plasma torches, and/or computer numerical control (CNC) cutters including lasers, mill bits, torches, water jets, routers, and the like), bending (e.g., manual, powered, or CNC hammers, pan brakes, press brakes, tube benders, roll benders, specialized machine presses, and the like), assembling (e.g., by welding, soldering, brazing, crimping, coupling with adhesives, riveting, using fasteners, and the like), molding or casting (e.g., die casting, centrifugal casting, injection molding, extrusion molding, matrix molding, three-dimensional (3D) printing techniques including fused deposition modeling, selective laser melting, selective laser sintering, composite filament fabrication, fused filament fabrication, stereolithography, directed energy deposition, electron beam freeform fabrication, and the like), and PCB and/or semiconductor manufacturing techniques (e.g., silk-screen printing, photolithography, photoengraving, PCB milling, laser resist ablation, laser etching, plasma exposure, atomic layer deposition (ALD), molecular layer deposition (MLD), chemical vapor deposition (CVD), rapid thermal processing (RTP), and/or the like).

The term “etch” or “etching” at least in some examples refers to a process in which a controlled quantity or thickness of material is removed (often selectively) from a surface by, for example, chemical reaction, electrolysis, or other means.

The term “fastener”, “fastening means”, or the like at least in some examples refers to a device that mechanically joins or affixes two or more objects together, and may include threaded fasteners (e.g., bolts, screws, nuts, threaded rods, and the like), pins, linchpins, r-clips, clips, pegs, clamps, dowels, cam locks, latches, catches, ties, hooks, magnets, molded or assembled joineries, and/or the like.

The terms “flexible,” “flexibility,” and/or “pliability” at least in some examples refer to the ability of an object or material to bend or deform in response to an applied force; “the term “flexible” is complementary to “stiffness.” The term “stiffness” and/or “rigidity” refers to the ability of an object to resist deformation in response to an applied force. The term “elasticity” refers to the ability of an object or material to resist a distorting influence or stress and to return to its original size and shape when the stress is removed. Elastic modulus (a measure of elasticity) is a property of a material, whereas flexibility or stiffness is a property of a structure or component of a structure and is dependent upon various physical dimensions that describe that structure or component.

The term “wear” at least in some examples refers to the phenomenon of the gradual removal, damaging, and/or displacement of material at solid surfaces due to mechanical processes (e.g., erosion) and/or chemical processes (e.g., corrosion). Wear causes functional surfaces to degrade, eventually leading to material failure or loss of functionality. The term “wear” at least in some examples also includes other processes such as fatigue (e.g., he weakening of a material caused by cyclic loading that results in progressive and localized structural damage and the growth of cracks) and creep (e.g., the tendency of a solid material to move slowly or deform permanently under the influence of persistent mechanical stresses). Mechanical wear may occur as a result of relative motion occurring between two contact surfaces. Wear that occurs in machinery components has the potential to cause degradation of the functional surface and ultimately loss of functionality. Various factors, such as the type of loading, type of motion, temperature, lubrication, and the like may affect the rate of wear.

The term “joint”, “articulation”, or “articular surface” at least in some examples refers to a connection made between bones, ossicles, or other hard structures in a body which link a skeletal system into a functional whole. Additionally or alternatively, the term “joint” at least in some examples refers to a connection between two bodies which allows movement. Additionally or alternatively, the term “joint” or “kinematic pair” at least in some examples refers to a connection between two physical objects that imposes constraints on their relative movement.

The term “joint dislocation” or “luxation” at least in some examples refers to a separation of a joint and/or when joint surfaces become disengaged. The term “subluxation” at least in some examples refers to an incomplete or partial dislocation of a joint.

The term “joint reduction” or “reduction” at least in some examples refers to a process or intervention by which a structure is brought back into its normal anatomic position, orientation, and/or alignment. Additionally or alternatively, term “joint reduction” or “reduction” at least in some examples refers to a procedure or other intervention to repair or otherwise align a dislocated joint and/or to repair a fracture.

The term “closed reduction” at least in some examples refers to a manipulation of bone fragments without surgical exposure of the fragments. The term “closed reduction internal fixation” or “CRIF” at least in some examples refers to a reduction without any open surgery, followed by internal fixation.

The term “open reduction” at least in some examples refers to situations where fracture fragments are exposed through surgical dissection of tissues. The term “open reduction internal fixation” or “ORIF” at least in some examples refers to the implementation of implants to guide the healing process of a bone, as well as the open reduction, or setting, of the bone.

The term “kinematic chain” at least in some examples refers to a collection or assembly of segments connected by joints that is/are used as a representation of a mechanical or biomechanical system.

The term “end-effector” at least in some examples refers to a portion of a kinematic chain that interacts with an environment outside of or separate from the kinematic chain.

The term “lateral” at least in some examples refers to directions or positions relative to an object spanning the width of a body of the object, relating to the sides of the object, and/or moving in a sideways direction with respect to the object.

The term “longitudinal” at least in some examples refers to directions or positions relative to an object spanning the length of a body of the object; relating to the top or bottom of the object, and/or moving in an upwards and/or downwards direction with respect to the object.

The term “linear” at least in some examples refers to directions or positions relative to an object following a straight line with respect to the object, and/or refers to a movement or force that occurs in a straight line rather than in a curve.

The term “lineal” at least in some examples refers to directions or positions relative to an object following along a given path with respect to the object, wherein the shape of the path is straight or not straight.

The term “normal” or “normal axis” at least in some examples refers to a line, ray, or vector that is perpendicular to a given object.

The term “vertical” at least in some examples refers to a direction aligned with the direction of the force of gravity (e.g., up or down). The term “horizontal” at least in some examples refers to a direction or plane that is perpendicular to the vertical direction.

The term “mechanical axis” at least in some examples refers to an axis that passes through the physical center of an optical element and/or is perpendicular to the outside edges of the optical element.

The terms “rotational symmetry” and “radial symmetry” at least in some examples refers to a property of a shape or surface that looks the same after some rotation by a partial turn. An object's degree of rotational symmetry is the number of distinct orientations in which it looks exactly the same for each rotation.

The terms “biaxial symmetry” or “bi-axial symmetry” at least in some examples refers to a property of a shape or surface that contains symmetrical designs on both horizontal and vertical axes.

The term “curvature” at least in some examples refers to a rate of change of direction of a curve with respect to distance along the curve.

The term “spherical” at least in some examples refers to an object having a shape that is or is substantially similar to a sphere.

The term “sphere” at least in some examples refers to a set of all points in three-dimensional space lying the same distance (the radius) from a given point (the center), or the result of rotating a circle about one of its diameters.

The term “toroidal” refers to an object having a shape that is or is substantially similar to a torus.

The term “torus” at least in some examples refers to a surface of revolution generated by revolving a circle in three-dimensional space about an axis that is coplanar with the circle.

The term “anamorphic surface” at least in some examples refers to a non-symmetric surface with bi-axial symmetry.

The term “freeform surface” at least in some examples refers to a geometric element that does not have rigid radial dimensions.

The term “vertex” at least in some examples refers to a corner point of a polygon, polyhedron, or other higher-dimensional polytope, formed by the intersection of edges, faces or facets of the object. A vertex is “convex” if the internal angle of the polygon (i.e., the angle formed by the two edges at the vertex with the polygon inside the angle) is less than π radians (180°); otherwise, it is a “concave” or “reflex” polygon.

The term “slope” at least in some examples refers to the steepness or the degree of incline of a surface.

The term “aspect” at least in some examples, depending on the context, refers to an orientation of a slope, which may be measured clockwise in degrees from 0 to 360, where 0 is north-facing, 90 is east-facing, 180 is south-facing, and 270 is west-facing.

The term “health care provider”, “healthcare provider”, or “HP” at least in some examples refers to an individual professional, facility, and/or organization licensed to provide healthcare diagnosis and treatment services including medication, surgery, medical devices, and the like. Examples of HPs include physicians, dentists, advanced practice providers (APPs) (e.g., physician assistants, nurses, pharmacists, midwives, chiropractors, social workers, psychologists, and/or the like), allied health professionals (e.g., technicians, therapists, hygienists, medical/dental assistants, nutritionists, scribes, counselors, physiologists, interpreters, radiation scientists, midwives, paramedics, pathologists, radiographers, sonographers, and/or the like), health professionals, individual hospitals, hospital networks, healthcare system, medical group, medical practice, clinics, and/or the like.

The term “medical practitioner” at least in some examples refers to a trained and licensed professional who specializes in the diagnosis, treatment, and prevention of illnesses and injuries in individuals. Examples of medical practitioners include physicians (doctors), dentists, nurses, physician assistants (PAs), physical therapists, occupational therapists, chiropractors, pharmacists, optometrists, podiatrists, emergency medical technicians (EMTs), and/or the like. For purposes of the present disclosure, the terms “medical practitioner” and “healthcare provider” may be used interchangeably unless context dictates otherwise.

The term “electronic health record” or “EHR” at least in some examples refers to a systematized collection of patient and population electronically stored health information in a digital format. Additionally or alternatively, the term “electronic health record” or “EHR” at least in some examples refers to a health record and/or personal health record (PHR) in electronic form. Additionally or alternatively, the term “electronic health record” or “EHR” at least in some examples refers to a collection of a patient's stored health information in a digital format. As examples, EHRs include a range of data, including demographics, medical history, progress notes, problems, medications, allergies, vital signs, immunization status, laboratory test results, radiology images, vital signs, personal statistics/data (e.g., age, weight, and the like), and billing information. For purposes of the present disclosure, the term “electronic health record” and “electronic medical record” may be used interchangeably, even though these terms may refer to different concepts in some cases or contexts. The term “personal health record” or “PHR” is a health record where health data and other information related to the care of a patient is maintained by the patient.

Unless otherwise specifically noted, articles depicted in the drawings are not necessarily drawn to scale. In the appended drawings, which are not necessarily drawn to scale, like numerals may describe similar components in different views. Like numerals having different letter suffixes may represent different instances of similar components.

Although the technology herein has been described with reference to particular embodiments, implementations, and configurations, it is to be understood that these are merely illustrative of the principles and applications of the present technology. It is therefore to be understood that numerous modifications may be made to the illustrative embodiments and that other arrangements may be devised without departing from the spirit and scope of the present technology as defined by the appended claims. By way of example only, components that are illustrated as being arranged in series may have a complementary configuration in parallel; similarly, components that are illustrated as being arranged in parallel may have a complementary configuration in series.

Aspects of the inventive subject matter may be referred to herein, individually and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

1. A joint dislocation simulation apparatus, comprising:
a first articular element;
a second articular element; and
connector element configured to couple the first articular element to the second articular element.

2. The apparatus of claim 1, wherein the first articular element and the second articular element simulate different bones that make up a joint.

3. The apparatus of claim 1, wherein the connector element simulates at least one of one or more ligaments, one or more tendons, one or more muscles, one or more cartilage, or one or more binding tissues.

4. The apparatus of claim 1, wherein the joint dislocation simulation apparatus is configured to simulate multiple types of joints, wherein the multiple types of joints include plane joints, ball and socket joints, hinge joints, pivot joints, condyloid joints, and saddle joints.

5. The apparatus of claim 1, wherein the first articular element includes at least one hole through a body of the first articular element.

6. The apparatus of claim 5, wherein the second articular element includes at least one hole through a body of the second articular element.

7. The apparatus of claim 6, wherein the connector element is configured to be inserted or threaded into the at least one hole of the first articular element and the at least one hole of the second articular element.

8. The apparatus of claim 7, wherein the at least one hole of the first articular element or at least one hole of the second articular element includes a corresponding track configured to receive the connector element and align the first articular element and the second articular element.

9. The apparatus of claim 1, wherein the second articular element comprises at least one socket.

10. The apparatus of claim 9, wherein the first articular element comprises at least one articulation surface configured to fit into the at least one socket of the second articular element when the joint dislocation simulation apparatus simulates a reduced joint.

11. The apparatus of claim 10, wherein the at least one socket is a concave surface.

12. The apparatus of claim 11, wherein the concave surface is formed between at least two articulation surfaces of the second articular element.

13. The apparatus of claim 10, wherein the at least one articulation surface extends laterally away from a body of the first articular element.

14. The apparatus of claim 10, wherein the at least one articulation surface extends longitudinally away from a body of the first articular element.

15. The apparatus of claim 10, wherein the at least one articulation surface of the first articular element is a first articulation surface, the first articular element comprises a second articulation surface configured to rest on an articulation surface of the second articular element when the joint dislocation simulation apparatus simulates a reduced joint.

16. The apparatus of claim 1, wherein the first articular element comprises at least one socket.

17. The apparatus of claim 16, wherein the second articular element comprises at least one articulation surface configured to fit into the at least one socket of the first articular element.

18. The apparatus of claim 1, wherein the first articular element and the second articular element are configured to be pulled away from one another, and the connector element is configured to resist a distorting influence caused by the first and second articular elements being pulled apart.

19. The apparatus of claim 1, wherein the connector element is formed from at least one elastic material.

20. A joint dislocation simulation apparatus, comprising at least two articular elements connected by at least one connector element, wherein at least one articular element of the at least two articular elements includes a socket and at least one articular element of the at least two articular elements includes an articulation surface configured to be inserted into the socket, and wherein the articulation surface is to rest outside of the socket to simulate a dislocated joint and the articulation surface is to rest inside the socket to simulate a reduced joint.
